(19) United States
(12) Patent Application Publication
(10) Pub. No.: US 2007/0237993 A1
(43) Pub. Date: Oct. 11, 2007

(54) Fuel cell reforming

(76) Inventors: Karin Carlsson, Goteborg (SE); Lifun Lin, Lincoln, MA (US); Ricardo F. Carreras, Southborough, MA (US)

Correspondence Address: FISH & RICHARDSON PC, P.O. BOX 1022, MINNEAPOLIS, MN, 55440-1022, US

(21) Appl. No.: 11/211,256

(22) Filed: Aug. 23, 2005

Related U.S. Application Data
(63) Continuation-in-part of application No. 10/394,822, filed on Mar. 21, 2003.

(51) Int. Cl. H01M 8/18; H01M 8/04

(52) U.S. Cl. 429/17; 429/21; 429/22

(57) ABSTRACT

Apparatus for chemoelectric generating includes an anode constructed and arranged to receive fuel, a cathode constructed and arranged to receive an oxidizer and an electrolyte that is positioned at least partially between the anode and the cathode. A controllable switch is constructed and arranged to selectively couple a load between the anode and the cathode. A controller is constructed and arranged to control at least one of the fuel received by the anode, the oxidizer received by the cathode, the controllable switch and to perform at least two reforming operations that are chosen from the group including a reverse-current charging operation a forward-current charging operation, an oxygen-less operation and an open-circuit operation.

### CROSS-REFERENCE TO RELATED APPLICATION

This patent application is a continuation-in-part (CIP) of U.S patent application Ser. No. 10/394,822, filed on Mar. 21, 2003, entitled CHEMOELECTRIC GENERATING, the entire disclosure of which is incorporated herein by reference.

The present invention relates to fuel cells and more particularly to fuel cell reforming.

### BACKGROUND OF THE INVENTION

Fuel cells are electrochemical devices that produce usable electricity by converting chemical energy to electrical energy. A typical fuel cell includes positive and negative electrodes separated by an electrolyte (e.g., a polymer electrolyte membrane (PEM)). In a typical direct methanol fuel cell (DMFC), a fuel, such as hydrogen or methanol, supplied to the negative electrode diffuses to the anode catalyst and dissociates into protons and electrons. The protons pass through the PEM to the cathode, and the electrons travel through an external circuit to supply power to a load.

### SUMMARY OF THE INVENTION

It is an important object of the invention to provide an improved fuel cell. In one aspect, the invention is embodied in a method of chemoelectric generating with a fuel cell. The method includes supplying a fuel to an anode of the fuel cell. An oxidizer is supplied to a cathode of the fuel cell. The method also includes performing at least two reforming operations on the fuel cell. The two reforming operations are chosen from a reverse current charging operation, a forward current charging operation, an oxygen-less operation, and an open circuit operation.

In one embodiment, the two reforming operations are performed either intermittently, simultaneously, or sequentially. For example, the reverse current charging operation, the oxygen-less operation, and the open circuit operation can be performed sequentially. Alternatively, the reverse current charging operation, the oxygen-less operation, and the open circuit operation can be performed intermittently. In other embodiments, the reverse current charging operation and the oxygen-less operation can be performed either intermittently, simultaneously or sequentially. In some embodiments, the oxygen-less operation and the open circuit operation can be performed either intermittently, sequentially, or simultaneously.

The forward current charging operation, the reverse current charging operation, the oxygen-less operation, and the open circuit operation can be performed either intermittently or sequentially.

The method can further include monitoring operating conditions of the fuel cell. The reforming operations can be performed when the monitored operating conditions indicate a performance decay of the fuel cell. The monitoring of the fuel cell can include monitoring the voltage of the fuel cell

In one embodiment, performing the reverse current charging operation in combination with at least one other reforming operation increases an operating voltage of the fuel cell. In one embodiment, performing the forward current charging operation in combination with at least one other reforming operation increases an operating voltage of the fuel cell. In one embodiment, performing the oxygen-less operation in combination with at least one other reforming operation increases an operating voltage of the fuel cell.

In some embodiments, supplying oxidizer to the cathode includes flowing air to the cathode or carrying a liquid containing the oxidizer to the cathode. The oxidizer can include oxygen from decomposing potassium chlorate or decomposing hydrogen peroxide.

The method can further include connecting a load between the anode and the cathode. The method can further include connecting a power supply between the anode and the cathode. The method can further include storing energy from the fuel cell.

In another aspect, the invention is embodied in an apparatus for chemoelectric generating. The apparatus includes an anode for receiving a fuel. A cathode receives an oxidizer. An electrolyte is positioned at least partially between the anode and the cathode. The apparatus also includes a controllable switch that is capable of switching in a load between the anode and the cathode. A controller controls at least one of the fuel received by the anode, the oxidizer received by the cathode, and the controllable switch. The controller performs at least two reforming operations including a reverse current charging operation, a forward current charging operation, an oxygen-less operation, and an open circuit operation.

The apparatus can further include a power supply that is coupled to between the controllable switch and one of the anode and the cathode. The apparatus can also include an energy storage device that is coupled to between the controllable switch and one of the anode and the cathode.

The fuel can include a carbon based fuel, a hydrogen fuel, or hydrogen contaminated with carbon monoxide (CO).

A fuel cell according to the invention includes an anode, the cathode, and the electrolyte. The controller can monitor at least one of a performance and an operating status of the fuel cell. The controller can monitor a current through the load. The oxidizer is supplied to the cathode by flowing air or liquid to the cathode. The oxidizer includes oxygen gas from air or oxygen from decomposing potassium chlorate or oxygen from decomposing hydrogen peroxide.

The controller can perform the at least two reforming operations intermittently, simultaneously, or sequentially. At least two of the reforming operations performed by the controller can include the reverse current charging operation, the oxygen-less operation, and the open circuit operation. At least two of the reforming operations performed by the controller can include the reverse current charging operation and the oxygen-less operation. At least two of the reforming operations performed by the controller comprise the oxygen-less operation and the open circuit operation. At least two of the reforming operations performed by the controller can include the forward current charging operation, the reverse current charging operation, the oxygen-less operation, and the open circuit operation. At least two of the reforming operations performed by the controller can include the forward current charging operation, the oxygen-less operation, and the open circuit operation.

Other features, objects, and advantages of the invention will be apparent from the following description when read in connection with the accompanying drawing in which:

### BRIEF DESCRIPTION OF SEVERAL VIEWS OF THE DRAWING

FIG. 1 shows a system block diagram of an operating fuel cell in accordance with the invention;

FIG. 2 shows a graph of voltage versus time, which demonstrates the effect of pre-treatment of a fuel cell using reverse current charging according to the invention;

FIG. 3 shows a graph of voltage versus time, which demonstrates the improvement in long-term decay of the fuel cell voltage using reverse current charging according to the invention;

FIG. 4 shows a graph of voltage versus time, which shows restoration of fuel cell voltage after cell reversal using reverse current charging according to the invention;

FIG. 5 shows a graph of voltage versus time, which shows the improvement of fuel cell voltage using reverse current charging and an increase in cathode side air flow rate according to the invention;

FIG. 6 is a graph of voltage versus time for various reforming operations according to the invention; and

FIG. 7 is a graph of voltage as a function of time and CO₂ on the cathode as a function of time according to the invention.

### DETAILED DESCRIPTION

The method and system of the invention will be illustrated with reference to a direct methanol fuel cell (DMFC). However, the methods and system are applicable to any type of fuel cell including, but not limited to, fuel cells that utilize carbon based fuels, such as methanol and ethanol. It also applies to hydrogen fuel cells that utilize either pure hydrogen or hydrogen contaminated with carbon monoxide (CO) as fuel.

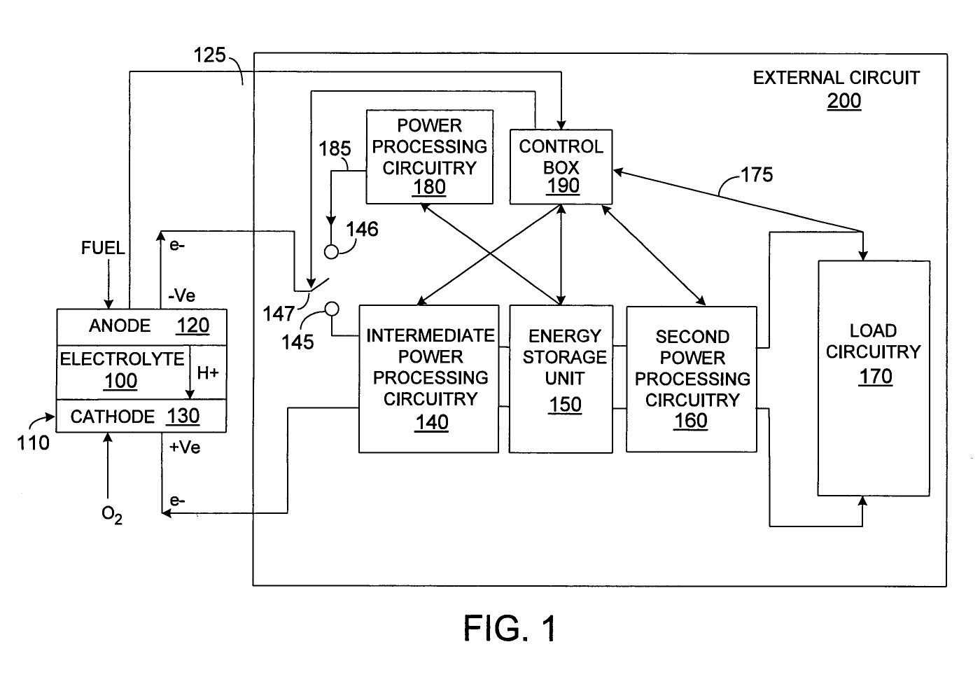

Referring to FIG. 1, there is shown a system block diagram of a DMFC 110 in which methanol is supplied to a negative electrode (anode) 120 that is electrochemically oxidized to produce electrons (e−) and protons (H⁺). A fuel supply 112 supplies the methanol to the anode 120. A valve 114 can control the flow rate of the methanol. A controller 190 controls the valve 114 through a signal transmission line 116. The protons produced by the anode 120 travel through an electrolyte 100 to the cathode 130. The electrolyte 100 can be in the form of a solid polymer electrolyte membrane (PEM). The electrons travel through an external circuit 200 (described below) to the positive electrode (cathode) 130. The electrons react with oxygen (or an oxidizer) and the protons that have been conducted through the PEM to form water and heat.

In one embodiment, an air or oxygen supply 132 supplies oxygen to the cathode 130. A valve 134 can control the flow rate of the oxygen. The controller 190 controls the value 134 through a signal transmission line 136. In alternate embodiments, oxygen can be supplied to the cathode 130 by a variety of methods, such as, for example, flowing gas or carrying via a liquid. For example, an oxidizer can be used to oxidize and/or deliver oxygen via a fluid or gas to the cathode 130. Many possible oxidizers, for example, potassium chlorate (KClO₃) and sodium chlorate (NaClO₃), can decompose and release oxygen when heated. Hydrogen peroxide (in a liquid form) also can decompose and release oxygen when contacting catalyst or acid. Although these oxidizers can directly contact the cathode 130 and react with electrons to complete the reduction reaction, they can also be decomposed first, and then released oxygen is delivered to cathode 130.

The electrodes are in contact with each side of the PEM and are typically in the form of carbon paper that is coated with a catalyst, such as platinum (Pt) or a mixture of platinum and ruthenium or a platinum ruthenium alloy (Pt—Ru). The electrochemical reactions occurring at the anode and cathode can be illustrated as follows:

| | |
|---|---|
| Anode (oxidation half-reaction): | CH₃OH + H₂O → CO₂ + 6H⁺ + 6e⁻ |
| Cathode (reduction half-reaction): | 3/2O₂ + 6H⁺ + 6e⁻ → 3H₂O |
| Net reaction: | CH₃OH + 3/2O₂ → CO₂ + 2H₂O |

The electrons generated at the anode travel through the external circuit 200 that includes power processing circuitry and load circuitry (discussed below). The external circuit 200 includes an energy storage device 150, which can include, e.g., a battery and/or capacitors. The energy from the fuel cell can be saved in the energy storage device 150. The external circuit 200 optionally can include first power processing circuitry 140, which conditions power generated from the fuel cell to properly supply the energy storage device 150, if necessary. The first power processing circuitry 140 can include, e.g., a DC/DC converter. The energy saved in energy storage device 150 can be used to power the load circuit 170 (e.g., a portable electronic device) via optional second power processing circuitry 160. Second power processing circuitry 160 may provide further power conditioning on the output from the energy storage device 150 depending on the requirements of the load circuit 170, and may include, e.g., a DC/DC or a DC/AC converter. The combination of first power processing circuitry 140, second power processing circuitry 160, and energy storage device 150 provide power to the load circuit 170. Generally, the fuel cell is constructed and arranged to provide steady power to the load circuit 170, and the extra energy saved in the power supply 150 can be further used to satisfy peak power demand from the load circuit 170.

When fuel cell performance decay is observed, various reforming operations (details to see below) can be applied to the fuel cell to interrupt its operation and improve its performance.

Fuel cell interruption can be provided by the interaction of the circuit 180, the second power processing circuitry 160, the energy storage device 150, and the controller 190. The circuit 180 and the controller 190 can include a hardware module, a software module, or combination thereof.

The first reforming operation includes applying a reverse current to the fuel cell. The circuitry 180 draws power from energy storage device 150 by providing a reverse current 185 to the fuel cell via switch or relay 147. The controller 190 controls the switch or relay 147 through signal transmission line 148. Circuitry 180 provides reverse current to the fuel cell by injecting a current, which is opposite to the normal fuel cell discharge current. Therefore, during reverse current charging, the cathode potential is higher than during normal operation, and the anode potential is lower than during normal operation.

Switch or relay 147 is connected to terminal 145 for normal fuel cell operation. Switch or relay 147 connects to switch terminal 146 during reverse current charging, and power from saved energy in energy storage device 150 is provided to circuitry 180. Energy storage device 150 continues to provide power to load 170 via second power processing circuitry 160 during reverse current charging. Controller 190 draws power from energy storage device 150 and controls how circuitry 180 provides reverse current pulses to the system. The reverse current charging pulses are defined by the number of reverse current pulses and the duration of each pulse. The reverse current pulses can further depend on the fuel cell specification, fuel cell operation status, fuel cell performance, and external circuitry operating conditions.

The controller 190 can provide periodic reverse current charging to the fuel cell to improve fuel cell performance depending on the fuel cell operating status (i.e., whether the fuel cell requires pretreatment, is in reversal condition, or has been operating for a long time and a decay in performance has been observed). Controller 190 monitors a variety of cell performance parameters, such as the fuel cell voltage, the load current 175, the second power processing circuitry 160, the energy storage device 150, the fuel cell operating status via status line 125, fuel cell reversal by monitoring the fuel supply status, operating time elapse, and long-term performance decay.

The reverse current charge pulses applied to the fuel cell can be controlled per monitored parameters via circuitry 180 and switch or relay 147. For example, the controller 190 can disable the first power processing circuitry 140 during reverse current charging. When a decay in fuel cell output voltage is observed, controller 190 can initially provide a rapid series of reverse current pulses to the cell to increase the level of fuel cell power output. The reverse current pulses can then be adjusted to be less frequent as determined by monitored cell performance, i.e., due to an observed increase and stabilization in cell output. Generally, the fuel cell is constructed and arranged to provide steady power to the load circuitry 170, and the extra energy saved in the energy storage device 150 can be further used to satisfy peak power demand from the load circuit 170.

The second reforming operation includes applying increased forward current to the fuel cell. This is also referred to as forward current charging. For example, the forward current can be increased by lowering impedance of load 170. Additionally, the forward current can be increased by modifying parameters in the circuitry 180, the first power processing circuitry 140, and/or the second power processing circuitry 160. In one embodiment, the forward current can be increased for a specific period of time (e.g., fifteen seconds) and then decreased for a specific period of time. The process can be repeated until the reforming operation is complete. Additionally, the second reforming operation can be combined with other reforming operations, such as the first reforming operation.

The third reforming operation includes open circuit (OC) operation. By open circuit operation, we mean that at least one output terminal of the fuel cell is disconnected from the circuit 140. The controller 190 can provide open circuit (OC) operation of the fuel cell by commanding the switch or relay 147 to disconnect an output terminal of the fuel cell from either terminal 145 or 146 or both terminals 145, 146. Substantially no current is flowing through the fuel cell in open circuit (OC) operation. In one embodiment, the fuel cell can operate in the open circuit state for a specific period of time (e.g., two minutes) and then returned to closed circuit operation for a specific period of time. The process can be repeated until the reforming operation is complete. Additionally, the third reforming operation can be combined with other reforming operations, such as the first and/or the second reforming operations.

The fourth reforming operation includes interrupting the oxygen supply to the fuel cell (without losing generality, this reforming operation will be referred to as oxygen-less operation in the following description where oxygen is supplied via flowing air). The controller 190 controls the flow rate of fuel from a fuel supply 112 with a valve 114. The controller 190 controls the flow rate of oxygen from an oxygen supply 132 with a valve 134. The valves 114 and 134 can be designed to precisely meter the amount of fuel and oxygen, respectively, supplied to the fuel cell. Additionally the valves 114 and 134 can close, thereby substantially preventing the flow of fuel and oxygen, respectively, to the fuel cell. Additionally, the fourth reforming operation can be combined with other reforming operations, such as the first, the second and/or the third reforming operations.

In operation, the controller 190 monitors a variety of cell performance parameters, such as the fuel cell voltage, load current 175, second power processing circuitry 160, and energy storage device 150. The controller 190 can also monitor fuel cell operating status via status line 125. The controller 190 can also monitor fuel cell reversal, the fuel supply status, operating time elapse, and long-term performance decay. The controller 190 can improve fuel cell performance by monitoring the cell performance parameters and intermittently applying one or more of the above-described four reforming operations either alone or in combination.

### EXAMPLES

Membrane electrode assemblies (MEA) were fabricated or purchased from commercial sources. An MEA was tested in a single cell with 16 cm² active area. The experiments were conducted using 1M methanol solution and compressed air. The reverse current was typically the same as the load current. The duration of reverse current charging ranged from a few seconds to several minutes. During charging, the cell voltage was greater than the open circuit voltage, with the cathode under oxidation and the anode under reduction conditions.

The MEA's were prepared as follows: Pt—Ru black (Johnson Matthey, London, UK) was mixed with a 5 wt % NAFION solution (Electrochem Inc, Woburn, Mass.) and water to form an ink. The anode electrode was then prepared by applying a layer of the obtained ink to a pre-teflonated (10 wt %) carbon paper (Toray, Torayca, Japan). A similar process was used to prepare the cathode, except that the Pt was used instead of PtRu black (Johnson Matthey, London, UK). The complete MEA was fabricated by bonding the anode electrode and the cathode electrode to a NAFION® N117 (Dupont, Wilmington, Del.) membrane. The MEA was assembled for testing between two heated graphite blocks with fuel from fuel supply 112 and air from air supply 132.

### Example 1

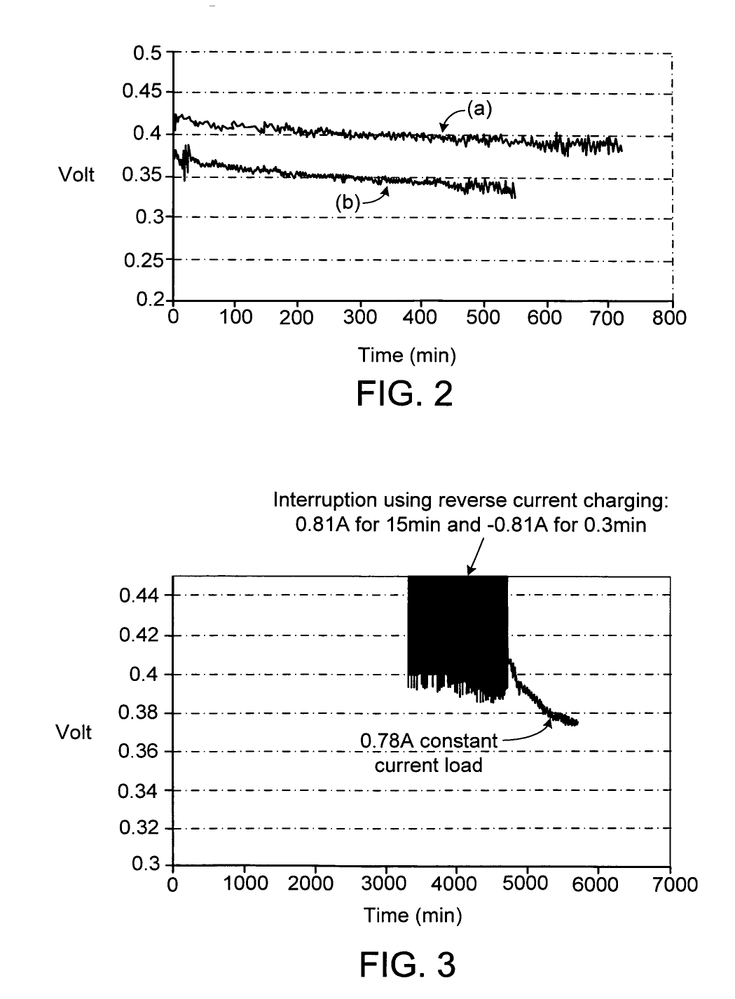

This example demonstrates performance improvement after pretreatment of a fuel cell prepared in accordance with the first reforming operation (i.e., reverse current charging). FIG. 2 is a graph of cell voltage as a function of time for the system of FIG. 1. Curve (b) illustrates the performance of the cell prior to pretreatment in accordance with the first reforming operation. Curve (a) illustrates increased performance of the cell after pretreatment in accordance with the first reforming operation. Specifically, curve (a) illustrates the performance of the cell after reverse current was applied briefly (e.g., about eighteen seconds) to the MEA.

The MEA was fabricated in-house with 4.5 mg/cm² of Pt—Ru and 3 mg/cm² of Pt. NAFION® N117 was used as the electrolyte membrane (Dupont, Wilmington, Del.). The performance (output voltage) of the freshly made MEA was tested at 70° C. with 2 A loading, both before and after pre-treatment.

The pretreatment via brief reverse current charging was done as follows: the reverse current charging was carried out on the MEA by periodically applying a 2 A, eighteen second reverse current pulse a total of six times over a one-hundred and eighty minute period. When not in the reverse current charging state, the cell output current was maintained at 2 A. The output voltage improvement due to the pretreatment was approximately 15%. It should be noted that a 15% voltage improvement as shown in FIG. 2 under constant output current conditions translates into a 15% power improvement. Note that power was provided by the cell at a higher voltage after reverse current charging.

### Example 2

This example demonstrates the effect of periodic reverse current charging on slowing down long-term fuel cell performance decay. Fuel cells are typically operated under constant load, i.e. in constant current mode. Long term operation in this mode results in a decay in the output voltage of the cell. In this example, the fuel cell operation was periodically interrupted manually and reverse current charging pulses were applied. In an operating system, these functions are provided by the system of FIG. 1. The circuitry 180 and controller 190 control the switch 147 by periodically switching between positions 145 and 146.

The MEA tested was prepared with 2.2 mg/cm² Pt—Ru (Johnson-Matthey) on the anode side, 3.3 mg/cm² Pt on the cathode side, with a NAFION® N117 membrane. Teflonized Toray carbon paper was used as the gas diffusion electrode. The cell was tested at 42° C. and with 550 cc/min air flow. The fuel cell operation was interrupted via interrupting load current by disconnecting the fuel cell from the load (0.78 A). During interruption, reverse current pulses were applied using the switch 147, circuitry 180, controller 190, and energy storage device 150.

The cell was tested for a first period of time with a current discharge/charge cycle of 0.81 A/15 min discharge followed by −0.81 A/0.3 min of reverse current charging. The cell was then further tested for a second period of time consisting solely of constant current discharge of 0.78 A. The curve of FIG. 3 shows the output voltage of the cell under test, for both periods of time. The cell experienced a performance decay of only 0.5 mV/hr during the time in which periodic interruption and reverse current charging occurred as compared to a performance decay of approximately 3.0 mV/hr for period of time in which constant current operation was occurring.

Note that the current discharge for the period of time during which periodic reverse current charging was occurring was maintained at a higher level (0.81 A) than it was during the period of time when the cell was operated under constant current load (0.78 A). This is done to ensure that sufficient energy is available during the reverse current charging period to satisfy the load 170 and the energy demand from the reverse current charging circuit 180.

### Example 3

This example describes restoration of fuel cell performance after cell reversal has occurred. During long term operation of a fuel cell, it is possible for the output voltage of one or more cells contained in a large cell stack to become reversed. When this occurs, the cell output voltage becomes negative. That is, during cell reversal, the anode becomes more positive than the cathode. One common cause for reversal is reactant depletion. Although cell reversal can be caused by depletion of reactants in either the anode or cathode, the greatest problem occurs when the anode fuel is restricted. For example, without fuel in the anode, carbon corrosion can occur and the anode catalyst can be damaged by excessive oxidation. The cell can be revived, however, using the current reversal procedure in accordance with the invention.

Cell reversal was simulated by occasionally operating a cell without fuel until the cell voltage became negative. By briefly applying a reverse current to the cell, the cell decay is reduced and much of the cell performance is restored.

An MEA was first tested with a defined load (discharge current), which is described below. After the cell voltage stabilized, the fuel supply 112 was interrupted, while the same amount of current was passed through the cell. This occurred for a period of time that was long enough to cause cell damage. The cell damage caused by cell reversal occurred when the cell voltage was lower than the original cell voltage under the same output current density condition after the fuel source was restored.

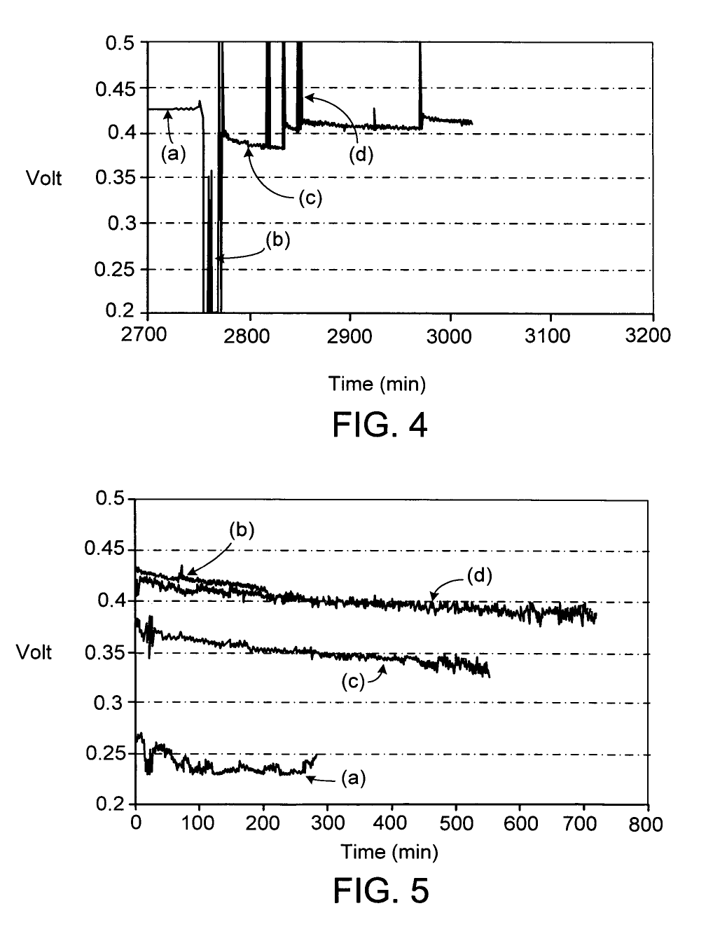

The MEA was purchased from Lynntech (College Station, Tex.) with catalyst precoated on the membranes. The anode contained 4 mg/cm² Pt—Ru, and the cathode contained 4 mg/cm² Pt. This MEA was tested with teflonized carbon paper as the anode gas diffusion electrode and gold mesh as the cathode gas diffusion electrode using 600 cc/min of airflow. FIG. 4 shows the fuel cell performance curve (voltage vs. time) at 1 A load at a temperature of 70° C. After testing for a period of time (curve (a) in FIG. 4), the fuel supply 112 was interrupted while the same amount of current was forced out of the cell. After a few minutes, the cell voltage became reversed (curve (b) in FIG. 4). The anode was more positive than the cathode with a cell voltage output of −1.7V. It should be noted that a portion of curve (b) in FIG. 4 that reaches −1.7V is outside the boundary of the graph. When the fuel supply 112 was restored, the output voltage was significantly lower than before cell reversal (curve (c) in FIG. 4). After applying a few brief reverse current charging pulses, most of the cell voltage was recovered (curve (d) in FIG. 4).

### Example 4

This example describes combining reverse current charging with increased air flow rate to the cathode 130. FIG. 5 shows the improvement of fuel cell voltage using reverse current charging along with an increase in the air flow rate to the cathode 130.

Using the MEA described in Example 1, the reverse current charging was tested at an air flow rate of 200 cc/min (curve (c) in FIG. 5) and 600 cc/min (curve (a) in FIG. 5). Before reverse current charging, the MEA had a lower voltage output at higher air flow rate (curve (a)) than the MEA with lower air flow rate (curve (c)). After reverse current charging, the MEA had a higher voltage output at the higher air flow rate of 600 cc/min (curve (b) in FIG. 5) than the MEA at the lower air flow rate of 200 cc/min (curve (d) in FIG. 5). Combining the reverse current charging operation with increased air flow rate to the cathode 130 can increase the output voltage of the MEA.

Additional combinations of reforming operations can also be used to improve and/or restore fuel cell performance and/or to pre-treat a fuel cell. The following combinations are illustrative examples. Many other combinations can be used within the scope of the invention. For example, combinations of operations including reverse current charging operation, forward current charging operation, oxygen-less operation, and open circuit operation can be used. The combination of oxygen-less operation and open circuit operation as well as the increased forward current reforming operation have also shown increased CO₂ conversion of cross-over methanol on the cathode.

The Membrane electrode assemblies (MEA) were fabricated in-house or purchased from commercial sources, such as Carbon paper from Toray, Torayca, Japan, Pt and PtRu catalyst from Johnson Mattey, London, UK, NAFRON® N117 membrane from Dupont, Wilmington, Del. and Sealed graphite test cell. The MEA's were prepared as follows: Pt—Ru black (Johnson Matthey, London, UK) was mixed with a 5 wt % NAFION® solution (Electrochem Inc, Woburn, Mass.) and water to form an ink. The anode electrode was then prepared by applying a layer of the obtained ink to a pre-teflonated (10 wt %) carbon paper (Toray, Torayca, Japan). A similar process was used to prepare the cathode, except that the Pt was used instead of PtRu black (Johnson Matthey, London, UK). The complete MEA was fabricated by bonding the anode electrode and the cathode electrode to a NAFION® N117 (Dupont, Wilmington, Del.) membrane. The MEA was assembled for testing between two heated graphite blocks with fuel and air feed.

The experiments were conducted at a temperature of 45° C., but experiments at 65° C. also showed positive effects of the described reforming operations. For reforming to improve cell performance, the flow rate of the oxygen source 132 to the cathode 130 normally ranged from 50-800 ml/min, but the invention is not limited to this experimental flow rate. For example, the flow rate can be lower. The fuel to the anode 120 was typically 3.2 wt %, but fuels up to 16 wt % fuel can also be used. The flow rate of the fuel ranged from 0.5-1.5 ml/min and 0.2-0.8 ml/min for a typical cell with 3.2 wt % and 16 wt % fuel, respectively.

The cells were generally pretreated as follows. At start-up, a reverse current charging operation was followed by a forward current charging operation (e.g., 0.5 A) for about five minutes. The cell was then subjected to fifteen seconds of an oxygen-less operation in combination with a forward current charging operation. The cell was then subjected to a combination of two minutes of an oxygen-less operation together with an open circuit operation. This is performed twice within a 5-15 minute time period. Then, desired combinations of the described reforming operations can be used every 2-24 hours.

An MEA was tested in either a single cell or double cells with 16 cm² active area. The experiments were conducted using a fuel supply 112 having a 1M methanol solution and an oxygen supply 132 consisting of compressed air. The reverse current in the reverse current charging operation was typically the same as the load current. The duration of reverse current charging ranged from a few seconds to several minutes. During reverse current charging, the cell voltage was greater than the open circuit voltage, with the cathode 130 under oxidation and the anode 120 under reduction conditions.

### Example 5

This example includes combining three reforming operations, namely, a reverse current charging operation, an oxygen-less operation, and an open circuit operation. The reforming operations can be performed in any combination as well as intermittently, simultaneously or sequentially. One method of reforming using these reforming operations is as follows assuming the fuel cell is operating with a 0.5 A forward current. In a first step, a reverse current (e.g., 0.5 A) is applied for a short period of time (e.g., 15-30 seconds). In a second step, the cell is again operated with a forward current (e.g., 0.5 A) for a period of time, for example, 1-15 minutes. In a third step, the airflow to the cathode is interrupted for a period of time (e.g., 15-30 seconds). In a fourth step, the cell is operated in open circuit mode for a period of time (e.g., about two minutes). In a fifth step, the airflow to the cathode is restored for a period of time (e.g., five seconds or more). In a sixth step, the cell is again operated with a forward current (e.g., 0.5 A). These steps can be repeated to create a reforming cycle. The time period between reforming cycles can be varied.

This example demonstrates performance improvement via pretreatment of a fuel cell prepared in accordance with the invention. The experimental conditions are as follows. The forward current charging operation uses a forward current of 0.5 A. The air flow rate at the cathode 130 is 100 ml/min. The temperature is 45° C. The flow rate of the fuel to the anode 120 is 0.5 ml/min of 1M fuel.

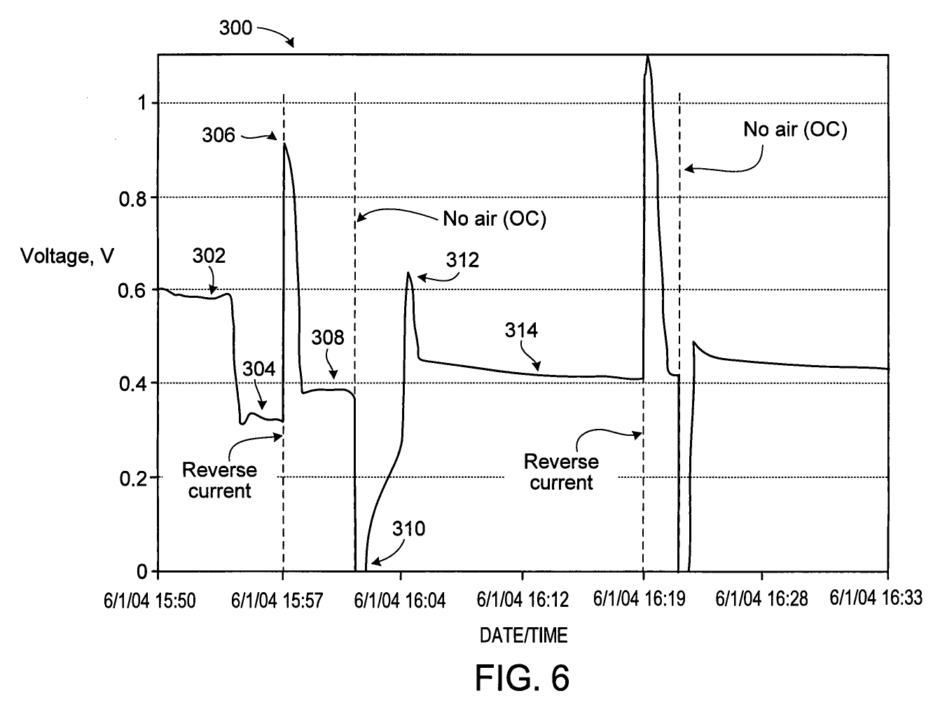

FIG. 6 illustrates a graph 300 of the voltage over time for each of the reforming operations in this example. The pretreatment procedure with two reforming cycles based on Example 5 (i.e., reverse current charging, in addition to oxygen-less (No air) operation and open circuit (OC) operation) typically improves the performance voltage of the cell by 10-30%.

A first voltage 302 of about 0.6V corresponds to an open circuit (OC) operation. A load is introduced which results in a second voltage 304 that is slightly greater than 0.3V. A reverse current charging operation is then applied which results in a voltage spike 306. A third voltage 308 corresponds to the termination of the reverse current charging operation. Oxygen-less (No air) operation results in a voltage drop 310. Restoring the oxygen results in a voltage spike 312. The voltage 314 under the load then settles to above 0.4V due to a combination of these reforming operations. The cycle is then repeated.

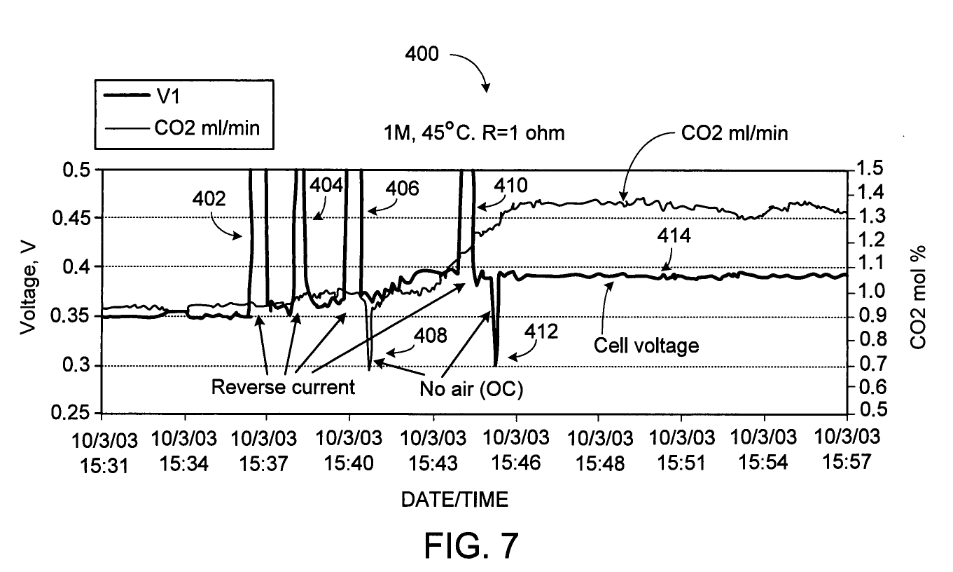

FIG. 7 is a graph 400 of voltage as a function of time and CO₂ on the cathode 130 as a function of time. Specifically, the graph 400 demonstrates that CO₂ on the cathode 130, which is a measure of the conversion of cross over methanol to CO₂, increases along with an improvement in cell performance as measured by the voltage by intermittently applying the reforming method described by Example 5 on a fuel cell prepared in accordance with the invention.

Specifically, FIG. 7 illustrates three subsequent reverse current operations 402, 404, 406 that result in a total cell improvement of 4% in voltage. The open circuit operation combined with the oxygen-less operation 408 resulted in an additional performance improvement of 9% for a total improvement of 13%. Also shown are another reverse current operation 410 and another open circuit operation combined with the oxygen-less operation 412.

### Example 6

This example includes combining two reforming operations, namely, a reverse current charging operation and an oxygen-less operation. The reforming operations can be performed in any combination as well as intermittently, simultaneously or sequentially. One method of reforming using these reforming operations is as follows assuming the fuel cell is operating with a 0.5 A forward current. In a first step, the airflow to the cathode is interrupted for a period of time (e.g., 15-30 seconds). In a second step, a reverse current (e.g., 0.5 A) is applied for a short period of time (e.g., 15-30 seconds). In a third step, the airflow to the cathode is restored and the cell is again operated with a forward current (e.g., 0.5 A).

### Example 7

This example includes combining three reforming operations, namely, a reverse current charging operation, an oxygen-less operation, and an open circuit operation. The oxygen-less operation and the open circuit operation can be performed simultaneously. One method of reforming using these reforming operations is as follows assuming the fuel cell is operating with a 0.5 A forward current. In a first step, the airflow to the cathode 130 is interrupted. After a period of time (e.g., 15-30 seconds), a reverse current (e.g., 0.5 A) is applied for a short period of time (e.g., 15-30 seconds). In a third step, the cell is operated in open circuit mode for a period of time (e.g., two minutes or more). In a fourth step, the airflow to the cathode is restored. After a period of time (e.g., five seconds), the cell is again operated with a forward current (e.g., 0.5 A).

### Example 8

This example includes combining four reforming operations, namely, a forward current charging operation, a reverse current charging operation, an oxygen-less operation, and an open circuit operation. The oxygen-less operation and the open circuit operation can be performed simultaneously. One method of reforming using these reforming operations is as follows assuming the fuel cell is operating with a 0.5 A forward current. In a first step, the forward current is increased for a period of time (e.g., 3 A for 15 seconds). In a second step, the forward current is decreased back to 0.5 A. These two steps are then repeated in a third and a fourth step. It should be noted that greater forward current in the first and third steps translates to greater improvement in performance. Also, it has been observed that greater performance improvement is achieved if the voltage in the second and fourth steps is reduced to almost zero.

In a fifth step, a reverse current (e.g., 3 A) is applied for a short period of time (e.g., 15 seconds). In a sixth step, the cell is operated with a forward current of 0.5 A for a short period of time (e.g., 15 seconds). These two steps are then repeated in a seventh and an eighth step. In a ninth step, the airflow to the cathode is interrupted and the cell is operated in open circuit mode for a period of time (e.g., two minutes or more). In a tenth step, the airflow to the cathode is restored. After a period of time (e.g., five seconds), the cell is again operated with a forward current (e.g., 0.5 A). It should be noted that the four reforming operations can be applied in different sequences and/or in different combinations from what are described herein.

There has been described novel apparatus and techniques for improving fuel cell performance. It is evident that those skilled in the art may now make numerous modifications of and departures from the specific apparatus and techniques disclosed herein without departing from the inventive concepts. Consequently, the invention is to be construed as embracing each and every novel feature and novel combination of features present in or possessed by the apparatus and techniques herein disclosed and limited solely by the spirit and scope of the appended claims.

What is claimed is:

1. A method of chemoelectric generating with a fuel cell having an anode and cathode comprising:
supplying a fuel to the anode;
supplying an oxidizer to the cathode; and
performing at least two reforming operations on the fuel cell chosen from the group comprising a reverse current charging operation, a forward current charging operation, an oxygen-less operation and an open circuit operation.

2. The method of claim 1 wherein the at least two reforming operations are performed intermittently.

3. The method of claim 1 wherein the at least two reforming operations are performed simultaneously.

4. The method of claim 1 wherein the at least two reforming operations are performed sequentially.

5. The method of claim 1 wherein performing the at least two reforming operations comprises sequentially performing the reverse current charging operation, the oxygen-less operation, and the open circuit operation.

6. The method of claim 1 wherein performing the at least two reforming operations comprises intermittently performing the reverse current charging operation, the oxygen-less operation and the open circuit operation.

7. The method of claim 1 wherein performing the at least two reforming operations comprises intermittently performing the reverse current charging operation and the oxygen-less operation.

8. The method of claim 1 wherein performing the at least two reforming operations comprises simultaneously performing the reverse current charging operation and the oxygen-less operation.

9. The method of claim 1 wherein performing the at least two reforming operations comprises sequentially performing the reverse current charging operation and the oxygen-less operation.

10. The method of claim 1 wherein performing the at least two reforming operations comprises intermittently performing the oxygen-less operation and the open circuit operation.

11. The method of claim 1 wherein performing the at least two reforming operations comprises simultaneously performing the oxygen-less operation and the open circuit operation.

12. The method of claim 1 wherein performing the at least two reforming operations comprises sequentially performing the oxygen-less operation and the open circuit operation.

13. The method of claim 1 wherein performing the at least two reforming operations comprises intermittently performing the forward current charging operation, the reverse current charging operation, the oxygen-less operation and the open circuit operation.

14. The method of claim 1 wherein performing the at least two reforming operations comprises sequentially performing the forward current charging operation, the reverse current charging operation, the oxygen-less operation and the open circuit operation.

15. The method of claim 1 further comprising monitoring operating conditions of the fuel cell.

16. The method of claim 15 wherein the at least two reforming operations are performed when the monitored operating conditions indicate a performance decay of the fuel cell.

17. The method of claim 15 wherein monitoring the operating conditions of the fuel cell includes monitoring the voltage of the fuel cell.

18. The method of claim 1 wherein performing the reverse current charging operation in combination with at least one other reforming operation increases operating voltage of the fuel cell.

19. The method of claim 1 wherein performing the forward current charging operation in combination with at least one other reforming operation increases operating voltage of the fuel cell.

20. The method of claim 1 wherein performing the open circuit operation in combination with at least one other reforming operation increases operating voltage of the fuel cell.

21. The method of claim 1 wherein performing the oxygen-less operation in combination with at least one other reforming operation increases operating voltage of the fuel cell.

22. The method of claim 1 wherein supplying oxidizer to the cathode comprises flowing air to the cathode.

23. The method of claim 1 wherein the supplying oxidizer comprises delivering a liquid containing the oxidizer to the cathode.

24. The method of claim 1 wherein supplying the oxidizer comprises decomposing potassium chlorate to provide oxygen.

25. The method of claim 1 wherein supplying the oxidizer comprises decomposing sodium chlorate to provide oxygen.

26. The method of claim 1 wherein supplying the oxidizer comprises decomposing hydrogen peroxide to provide oxygen.

27. The method of claim 1 and further comprising connecting a load between the anode and the cathode.

28. The method of claim 1 and further comprising connecting a power supply between the anode and the cathode.

29. The method of claim 1 and further comprising storing energy from the fuel cell.

30. Apparatus for chemoelectric generating, comprising:
an anode constructed and arranged to receive fuel;
a cathode constructed and arranged to receive an oxidizer;
an electrolyte that is positioned at least partially between the anode and the cathode;
a controllable switch that is capable of selectively coupling a load between the anode and the cathode; and
a controller constructed and arranged to control at least one of the fuel received by the anode, the oxidizer received by the cathode, the controllable switch, and to perform at least two reforming operations that are chosen from the group comprising a reverse current charging operation, a forward current charging operation, an oxygen-less operation and an open circuit operation.

31. The apparatus of claim 30 and further comprising a power supply that is coupled between the controllable switch and one of the anode and the cathode.

32. The apparatus of claim 30 and further comprising an energy storage device that is coupled between the controllable switch and one of the anode and the cathode.

33. The apparatus of claim 30 and further comprising a carbon based fuel received by the anode.

34. The apparatus of claim 30 and further comprising hydrogen fuel received by the anode.

35. The apparatus of claim 34 wherein the fuel comprises hydrogen contaminated with carbon monoxide (CO).

36. The apparatus of claim 30 wherein the anode, the cathode and the electrolyte comprise a fuel cell.

37. The apparatus of claim 36 wherein the controller is constructed and arranged to monitor at least one of a performance and an operating status of the fuel cell.

38. The apparatus of claim 30 wherein the controller is constructed and arranged to monitor a current through a load when coupled between the anode and cathode.

39. The apparatus of claim 30 constructed and arranged to supply the oxidizer is supplied to the cathode by flowing air to the cathode.

40. The apparatus of claim 30 constructed and arranged to supply the oxidizer to the cathode by flowing liquid to the cathode.

41. The apparatus of claim 30 constructed and arranged to supply the oxidizer to the cathode with oxygen gas from air.

42. The apparatus of claim 30 constructed and arranged to supply the oxidizer with oxygen from decomposing potassium chlorate.

43. The apparatus of claim 30 constructed and arranged to supply the oxidizer with oxygen from decomposing hydrogen peroxide.

44. The apparatus of claim 30 wherein the controller performs the at least two reforming operations intermittently.

45. The apparatus of claim 30 wherein the controller is constructed and arranged to perform the at least two reforming operations simultaneously.

46. The apparatus of claim 30 wherein the controller is constructed and arranged to perform the at least two reforming operations sequentially.

47. The apparatus of claim 30 wherein the at least two reforming operations performed by the controller comprise the reverse current charging operation, the oxygen-less operation, and the open circuit operation.

48. The apparatus of claim 30 wherein the at least two reforming operations performed by the controller comprise the reverse current charging operation and the oxygen-less operation.

49. The apparatus of claim 30 wherein the at least two reforming operations performed by the controller comprise the oxygen-less operation and the open circuit operation.

50. The apparatus of claim 30 wherein the at least two reforming operations performed by the controller comprise the forward current charging operation, the reverse current charging operation, the oxygen-less operation and the open circuit operation.

51. The apparatus of claim 30 wherein the at least two reforming operations performed by the controller comprise the forward current charging operation, the oxygen-less operation and the open circuit operation.
